(19) United States
(12) Patent Application Publication
(10) Pub. No.: US 2024/0347328 A1
(43) Pub. Date: Oct. 17, 2024

(54) Mass Spectrometer and Mass Spectrometry Method

(71) Applicant: SHIMADZU CORPORATION

(72) Inventors: Kazutaka MITSUI, Kyoto-shi (JP); Hidenori TAKAHASHI, Kyoto-shi (JP); Yuta MIYAZAKI, Kyoto-shi (JP)

(21) Appl. No.: 18/294,930

(22) PCT Filed: Mar. 25, 2022
(86) PCT No.: PCT/JP2022/014581

§ 371 Date: Feb. 2, 2024

(30) Foreign Application Priority Data
Aug. 2, 2021 (JP) 2021-126980

(51) Int. Cl. H01J 49/00; H01J 49/04

(52) U.S. Cl. CPC H01J 49/0031; H01J 49/005; H01J 49/0422

(57) ABSTRACT

The method of operating a mass spectrometer includes: introducing precursor ions into a reaction chamber; generating radicals by generating plasma by supplying source gas and radio-frequency power to a radical generation chamber for a predetermined period by transmitting a predetermined control signal to a source gas supply part and a radio-frequency power supply part; generating product ions by introducing the radicals into the reaction chamber; measuring an intensity of light having a wavelength band including a wavelength of light emitted from the plasma inside the radical generation chamber; and determining and notifying an abnormality of the mass spectrometer on a basis of a fact that the intensity of the light exceeds a predetermined abnormality determination threshold value during a period other than the predetermined period.

### TECHNICAL FIELD

The present invention relates to a mass spectrometer and a mass spectrometry method.

### BACKGROUND ART

A mass spectrometry method is widely used in order to identify a sample component such as a polymer compound contained in a sample and analyze its structure, in which an ion having a specific mass-to-charge ratio is selected as a precursor ion from ions derived from a sample component, and product ions generated by dissociating the precursor ion are separated according to their mass-to-charge ratio, and detected.

Many of polymer compounds are organic substances having a hydrocarbon chain as a main skeleton. In order to know characteristics of such a polymer compound, it is effective to obtain information such as presence or absence of an unsaturated bond between carbon atoms and the presence or absence of a characteristic functional group. Therefore, recently, a radical attachment dissociation method has been proposed in which radicals are attached to precursor ions derived from a sample component to dissociate the precursor ions at a position of unsaturated bonds between carbon atoms or specific functional groups.

For example, Patent Literatures 1 and 2 disclose that precursor ions introduced into a reaction chamber is irradiated with hydrogen radicals or the like to be attached, and the precursor ions are dissociated selectively at the position of peptide bonds. In addition, Patent Literatures 3 and 4 disclose that precursor ions introduced into a reaction chamber is irradiated with oxygen radicals or the like to be attached, and the precursor ions are dissociated selectively at the position of unsaturated bonds contained in hydrocarbon chains.

Radicals used in the radical attachment dissociation method are generated, for example, by generating inductively coupled plasma in a radical generation chamber into which source gas is introduced. Patent Literature 5 and Non Patent Literature 1 describe a radical supply part having a configuration in which a helical antenna is wound around an outer periphery of a quartz tube, source gas is introduced into the quartz tube, radio-frequency power is supplied to the antenna to generate inductively coupled plasma to generate radicals, and the radicals are transported to a reaction chamber through a quartz capillary.

### CITATION LIST

### Patent Literature

Patent Literature 1: WO 2015/133259 A
Patent Literature 2: WO 2018/186286 A
Patent Literature 3: WO 2019/155725 A
Patent Literature 4: WO 2020/240908 A
Patent Literature 5: JP 2020-177784 A

### Non Patent Literature

Non Patent Literature 1: Hidenori Takahashi, Yuji Shimabukuro, Daiki Asakawa, Akihito Korenaga, Masaki Yamada, Shinichi Iwamoto, Motoi Wada, Koichi Tanaka, “Identifying Double Bond Positions in Phospholipids Using Liquid Chromatography-Triple Quadrupole Tandem Mass Spectrometry Based on Oxygen Attachment Dissociation”, Mass Spedctrometry, Volume 8, Issue 2, Pages S0080, 2020

### SUMMARY OF INVENTION

### Technical Problem

In the mass spectrometer including the radical supply part, a predetermined start control signal is sent from a measurement controller to a radio-frequency power supply so as to supply the radio-frequency power to the radical generation chamber in accordance with the timing at which the ions derived from the sample component are introduced into the reaction chamber. In addition, when the generation of product ions is completed in the reaction chamber, a predetermined end control signal is sent from the measurement controller to the radio-frequency power supply. However, when a failure occurs in transmission or reception of a control signal between the measurement controller and the radio-frequency power supply, for example, when the end control signal for stopping the supply of the radio-frequency power is not delivered, the radio-frequency power is supplied even during an unnecessary period, the plasma is continuously generated, and the temperature in the radical generation chamber rises. The heat resistance temperature of the quartz tube constituting the radical generation chamber and the quartz capillary itself as a transport tube is as high as 1000° C. or higher, but the heat resistance temperature of the O-ring used for fixing these and sealing the radical generation chamber is as low as 100 to 200° C. Therefore, when the temperature in the radical generation chamber continues to rise, a member having a low heat-resistant temperature may be damaged, and the vacuum in the radical generation chamber may be broken. Since the radical generation chamber and the reaction chamber of the mass spectrometer communicate with each other by the quartz capillary, vacuum in the mass spectrometer is also destroyed when vacuum is destroyed in the radical generation chamber, and the inside of the mass spectrometer is contaminated.

An object of the present invention is to provide a technique that allows a user to quickly find that plasma is generated at an undesired time in a mass spectrometer that generates radicals from source gas by generating plasma in a radical generation chamber and irradiates precursor ions with the radicals to generate product ions.

### Solution to Problem

A mass spectrometry method according to the present invention made to solve the above problems includes:
a step of introducing precursor ions into a reaction chamber;
a step of generating radicals from source gas by generating plasma inside a radical generation chamber by supplying the source gas and radio-frequency power to the radical generation chamber for a predetermined period by transmitting a predetermined control signal to a source gas supply part and a radio-frequency power supply part;
a step of generating product ions by introducing the radicals into the reaction chamber;
a step of measuring an intensity of light having a wavelength band including a wavelength of light emitted from the plasma inside the radical generation chamber; and
a step of determining and notifying an abnormality of the mass spectrometer on the basis of a fact that the intensity of the light exceeds a predetermined abnormality determination threshold value during a period other than the predetermined period.

Furthermore, a mass spectrometer according to the present invention made to solve the above problems includes:
a threshold storage part in which an abnormality determination threshold value is stored;
a reaction chamber into which precursor ions are introduced;
a radical generation chamber;
a source gas supply part configured to supply source gas to the inside of the radical generation chamber;
a radio-frequency power supply part configured to supply radio-frequency power for generating plasma inside the radical generation chamber;
a plasma generation controller configured to supply the source gas and the radio-frequency power to the radical generation chamber for a predetermined period by transmitting a predetermined control signal to the source gas supply part and the radio-frequency power supply part to generate plasma inside the radical generation chamber;
a photodetector configured to measure intensity of light having a wavelength band including a wavelength of light emitted from the plasma inside the radical generation chamber;
a light intensity determination part configured to determine whether or not the intensity of light measured by the photodetector during a period other than the predetermined period exceeds the abnormality determination threshold value; and
an abnormality notifier configured to notify an abnormality of the mass spectrometer when the light intensity determination part determines that the intensity of the light exceeds the abnormality determination threshold value.

### Advantageous Effects of Invention

In the mass spectrometry method and the mass spectrometer according to the present invention, a predetermined control signal is transmitted to the source gas supply part and the radio-frequency power supply part, the source gas and the radio-frequency power are supplied to the radical generation chamber for a predetermined period to generate plasma inside the radical generation chamber, and radicals are generated from the source gas. The predetermined period is typically a part or all of the period during which precursor ions derived from the sample component to be analyzed are introduced into the reaction chamber. In the present invention, the intensity of light having a wavelength band including the wavelength of light emitted from the plasma generated in the radical generation chamber is measured, the abnormality of the mass spectrometer is determined on the basis of a fact that the intensity of light exceeds a predetermined abnormality determination threshold value during a period other than the predetermined period, that is, an unnecessary period, and the abnormality is notified. Therefore, on the basis of this notification, the user can quickly confirm that the plasma is generated at an undesired timing due to the abnormality of the mass spectrometer.

### BRIEF DESCRIPTION OF DRAWINGS

FIG. 1 is a configuration diagram of a main part of an embodiment of a mass spectrometer according to the present invention.

FIG. 2 is a schematic configuration diagram of a radical supply part in the mass spectrometer of the present embodiment.

FIG. 3 is a flowchart showing a procedure of an embodiment of a mass spectrometry method according to the present invention.

FIG. 4 is an example of a timing of light irradiation in the present embodiment.

FIG. 5 is another example of a timing of light irradiation in the present embodiment.

FIG. 6 is still another example of a timing of light irradiation in the present embodiment.

FIG. 7 is a diagram for explaining an output signal from a photodetector in the present embodiment.

FIG. 8 is a diagram for explaining a determination result of the output signal from the photodetector in the present embodiment.

### DESCRIPTION OF EMBODIMENTS

Hereinafter, an embodiment of a mass spectrometer and a mass spectrometry method according to the present invention will be described with reference to the drawings.

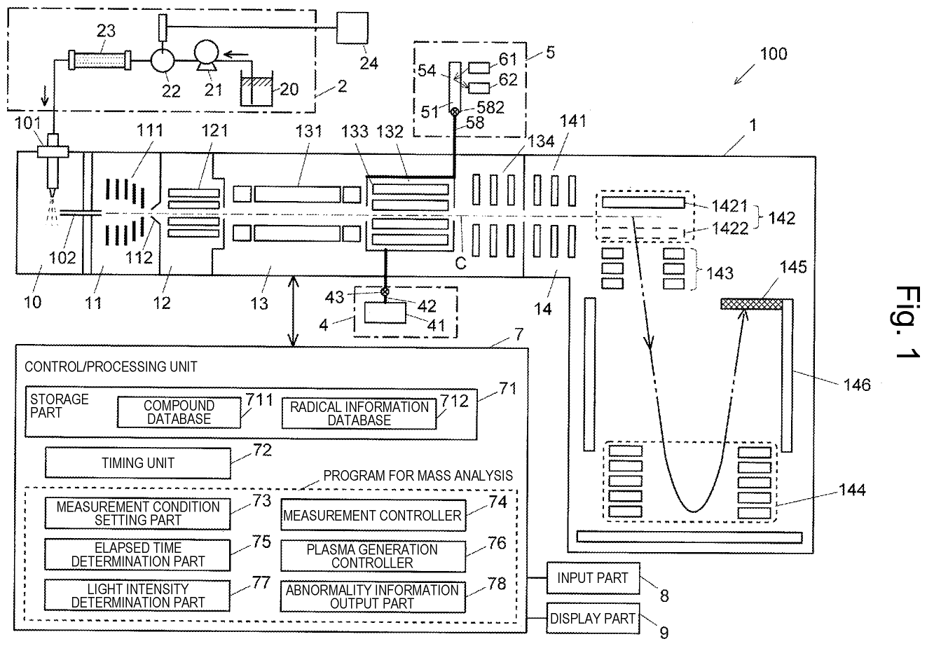

FIG. 1 is a configuration diagram of a main part of a liquid chromatograph mass spectrometer 100 in which a mass spectrometer 1 of the present embodiment is combined with a liquid chromatograph 2.

The liquid chromatograph 2 includes a mobile phase container 20 that stores a mobile phase, a liquid feeding pump 21 that feeds the mobile phase, an injector 22, and a column 23. In addition, to the injector 22, an autosampler 24 configured to introduce a plurality of liquid samples into the injector in a predetermined order is connected.

The mass spectrometer 1 includes a main body including an ionization chamber 10 at substantially atmospheric pressure and a vacuum chamber, and a control/processing unit 7. The vacuum chamber includes a first intermediate vacuum chamber 11, a second intermediate vacuum chamber 12, a third intermediate vacuum chamber 13, and an analysis chamber 14 in this order from the ionization chamber 10, and has a configuration of a multi-stage differential exhaust system with increasing degree of vacuum in this order.

The ionization chamber 10 is provided with an electrospray ionization probe (ESI probe) 101 for nebulizing a liquid sample while imparting electric charges to the liquid sample. Sample components separated in the column 23 of the liquid chromatograph 2 are sequentially introduced into the ESI probe 101.

The ionization chamber 10 and the first intermediate vacuum chamber 11 communicate with each other through a small-diameter heated capillary 102. In the first intermediate vacuum chamber 11, an ion lens 111 is disposed that includes a plurality of ring-shaped electrodes having different diameters and focuses ions in the vicinity of an ion optical axis C that is a central axis of a flight path of ions.

The first intermediate vacuum chamber 11 and the second intermediate vacuum chamber 12 are separated from each other by a skimmer 112 having a small hole at its top. In the second intermediate vacuum chamber 12, an ion guide 121 is disposed that includes a plurality of rod electrodes disposed so as to surround the ion optical axis C and focuses the ions in the vicinity of the ion optical axis C.

In the third intermediate vacuum chamber 13, there are disposed: a quadrupole mass filter 131 to separate the ions according to their mass-to-charge ratio; a collision cell 132 including a multipole ion guide 133 inside; and an ion guide 134 to transport the ions discharged from the collision cell 132. The ion guide 134 includes a plurality of ring-shaped electrodes having a same diameter.

A collision gas supply part 4 is connected to the collision cell 132. The collision gas supply part 4 includes: a collision gas source 41; a gas introduction flow path 42 for introducing gas from the collision gas source 41 into the collision cell 132; and a valve 43 for opening and closing the gas introduction flow path 42. As the collision gas, for example, an inert gas such as a nitrogen gas or an argon gas is used. In addition to a measurement example described later in which precursor ions are dissociated by a radical attachment reaction, information on product ions having a molecular structure different from that of product ions generated by the radical attachment reaction can be collected by performing measurement in which a compound contained in the same liquid sample is cleaved by collision-induced dissociation (CID).

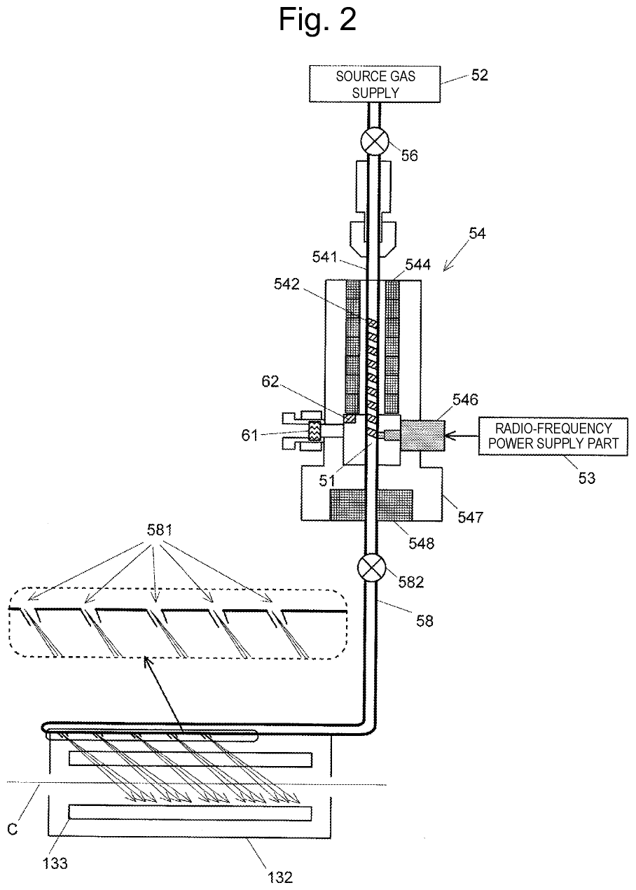

In addition, a radical supply part 5 is also connected to the collision cell 132. As illustrated in FIGS. 1 and 2, the radical supply part 5 includes a radical source 54 in which a radical generation chamber 51 is formed, a vacuum pump (not illustrated) configured to exhaust the radical generation chamber 51, a source gas supply 52 configured to supply gas (source gas) as a source of radicals, and a radio-frequency power supply part 53. A valve 56 for adjusting a flow rate of the source gas is provided in a flow path from the source gas supply 52 to the radical generation chamber 51.

The radical source 54 has a tubular body 541 made of a dielectric, and an internal space thereof serves as a radical generation chamber 51. A helical antenna 542 is wound around the outer periphery of a portion located inside a magnet 544 of the tubular body 541.

In addition, the radical source 54 is provided with a radio-frequency power input part 546. The radio-frequency power supply part 53 supplies radio-frequency power to the radio-frequency power input part 546. The radical source 54 further includes a flange 547 for fixing a tip portion of the radical source 54. The flange 547 accommodates a hollow cylindrical magnet 548 and forming a pair with the magnet 544. The magnets 544 and 548 generate a magnetic field inside the tubular body 541 (radical generation chamber 51) to easily generate and maintain plasma by the action.

In the present embodiment, a pulse width modulated (PWM) control signal is transmitted from the plasma generation controller 76 (described later) to the radio-frequency power supply part 53, and the radio-frequency power to be turned on/off is supplied to the radio-frequency power input part 546 accordingly. The frequency of the radio-frequency power is, for example, 100 Hz, and the duty ratio (the ratio of the ON period to one cycle) is, for example, 20%. The frequency of the radio-frequency power only needs to be appropriately determined according to a response speed of a photodetector to be described later. Specifically, for example, in a case of a photodiode having a general response characteristic in which the response speed of a signal is about 1.5 μs, the rise and fall of the signal require about 3 us in total. Therefore, when such a general photodiode is used for the photodetector, the frequency of the radio-frequency power only needs to be set to an appropriate value of 333 kHz or less in consideration of the duty ratio of ON/OFF. Of course, a photodiode or the like that responds at a higher speed may be used as the photodetector 62, but in this case, the device becomes expensive.

A light source 61 configured to emit light having a predetermined wavelength and the photodetector 62 are disposed at a position facing the radical generation chamber 51 of the radical source 54. The photodetector 62 detects light having a wavelength band including the wavelength of light emitted from the plasma. As the photodetector 62, it is preferable to use a photodetector having no sensitivity to light emitted from the light source 61. In the present embodiment, an LED light source (UV-LED) configured to emit deep ultraviolet light is used as the light source 61, and a photodiode having sensitivity in a visible light region (that does not detect ultraviolet light) is used as the photodetector 62. As a result, the light emission of the plasma can be detected without being affected by the light emitted from the light source 61. The photodetector 62 only needs to be a device that acquires a measurement value corresponding to the intensity of incident light, and a device other than a photodiode may be used. For example, a phototransistor that operates similarly to a photodiode, a photoresistor using CdS (cadmium sulfide), the photoresistor having a resistance value that changes according to the intensity of incident light, or other device can be used as the photodetector 62.

The deep ultraviolet light with which the radical generation chamber 51 is irradiated in the present embodiment adversely affects skin cancer, cataract, and the like when a human body is irradiated with the deep ultraviolet light. Therefore, the inside of the radical generation chamber 51 is kept airtight, and the radical generation chamber 51 is sealed before the measurement so that the light inside the radical generation chamber 51 does not exit to the outside and the light outside the radical generation chamber 51 does not enter the inside.

A transport tube 58 for transporting radicals generated in the radical generation chamber 51 to the collision cell 132 is connected to an outlet end of the radical source 54 via a valve 582. The transport tube 58 is an insulating pipe, and for example, a quartz glass pipe or a borosilicate glass pipe can be used.

A plurality of head parts 581 are provided in a portion of the transport tube 58 disposed along a wall surface of the collision cell 132. Each head part 581 is provided with an inclined cone-shaped irradiation port, and is irradiated with radicals in a direction intersecting a central axis (ion optical axis C) of a flight direction of ions. As a result, ions flying inside the collision cell 132 can be uniformly irradiated with the radicals.

The analysis chamber 14 includes: an ion transport electrode 141 for transporting the incident ions from the third intermediate vacuum chamber 13; an orthogonal acceleration electrode 142 including a pair of an expulsion electrode 1421 and a lead-in electrode 1422 disposed in such a manner as to face each other across the incident optical axis of the ions (an orthogonal acceleration area); an acceleration electrode 143 for accelerating the ions ejected to a flight space by the orthogonal acceleration electrode 142; a reflectron electrode 144 for forming a return path for the ions within the flight space; an ion detector 145; and a flight tube 146 configured to define a periphery of the flight space. The ion detector 145 is, for example, an electron multiplier or a multichannel plate.

The control/processing unit 7 controls operations of each part and has a function of storing and analyzing data obtained by the photodetector 62 and the ion detector 145. The control/processing unit 7 includes a storage part 71 and a timing unit 72. The storage part 71 stores a compound database 711 and a radical information database 712. The compound database 711 stores information such as measurement conditions (retention time, mass-to-charge ratio of precursor ions, radical species irradiated at the time of analysis of the sample) and product ion spectra of known compounds.

In addition, the radical information database 712 stores, for each radical species, information on the kind of the source gas used for generating the radical, the flow rate of the source gas, the magnitude of the radio-frequency power, the PWM waveform (frequency and duty ratio), and the like. For the flow rate of the source gas and the magnitude of the radio-frequency power, two kinds of plasma generation conditions (a first plasma generation condition and a second plasma generation condition) are prepared, and are stored together with information on a reference time for properly using them. The first plasma generation condition is used when a time equal to or longer than a reference time has elapsed since the previous radical generation, and when the plasma is not ignited under the second plasma generation condition described later. The second plasma generation condition is used when the elapsed time from the previous radical generation is less than the reference time. In the second plasma generation condition, the flow rate of the source gas and/or the magnitude of the radio-frequency power are set to values smaller than those in the first plasma generation condition. In the present embodiment, the fact that radio-frequency power is large is that the amount of power supplied per unit time is large, and specifically includes both a case where the duty ratio of the PWM waveform is the same and the amplitude is large and a case where the duty ratio is the same and the duty ratio is large.

A part of the radicals generated in the radical generation chamber 51 remains inside the radical generation chamber 51 and gradually disappears as time passes. When the source gas is introduced in a state where radicals remain in the radical generation chamber 51, the molecules of the source gas are excited by contact with the radicals and are easily radicalized. Therefore, radicals can be generated from the source gas even when the flow rate of the source gas and/or the radio-frequency power are suppressed to be small as compared with the case where no radicals are present in the radical generation chamber 51. The reference time corresponds to a time during which radicals can be regarded as remaining in the radical generation chamber 51. When the elapsed time from the previous generation of radicals is less than the reference time, the consumption of the source gas and the power can be reduced by suppressing the flow rate of the source gas and/or the supply amount of the radio-frequency power. Since the time during which the radical remains in the radical generation chamber 51, and the flow rate of the source gas and the magnitude of the radio-frequency power necessary for the generation of the radical depend on the volume and structure of the radical generation chamber 51, specific values of the length of the reference time, and the flow rate of the source gas and the magnitude of the radio-frequency power under the first radical irradiation condition and the second radical irradiation condition only needs to be set for each device by performing preliminary experiments or simulations.

Furthermore, in the storage part 71, two types of threshold values (a first threshold and a second threshold) related to the detection intensity of the photodetector 62 are stored. The first threshold (corresponding to the plasma ignition threshold in the present invention) is used to determine whether or not the plasma is ignited. The first threshold may be a value common to both when the plasma is ignited using the first plasma generation condition and when the plasma is ignited using the second plasma generation condition, but only needs to be a different value for each generation condition. The second threshold (corresponding to the abnormality determination threshold in the present invention) is used to detect the occurrence of an abnormality in the device. The amount of plasma generated in the radical generation chamber 51 varies depending on plasma generation conditions, the configuration of the radical generation chamber 51, or the arrangement of the photodetector 62. Therefore, the first threshold and the second threshold also only need to be set for each device by performing a preliminary experiment, simulating, or the like. In the present embodiment, the first threshold and the second threshold are set to different values, but the first threshold and the second threshold may be the same value.

In addition, the storage part 71 stores a method file describing measurement conditions when measurement to be described later is performed, and information for converting a time of flight of an ion into a mass-to-charge ratio of the ion.

The control/processing unit 7 further includes a measurement condition setting part 73, a measurement controller 74, an elapsed time determination part 75, a plasma generation controller 76, a light intensity determination part 77, and an abnormality information output part 78 as functional blocks. The entity of the control/processing unit 7 is a general personal computer including a control board on which a circuit necessary for the operation of each part is formed and to which an input part 8 and a display part 9 are connected, and embodies the functional blocks described above by a processor executing a mass analysis program installed in advance.

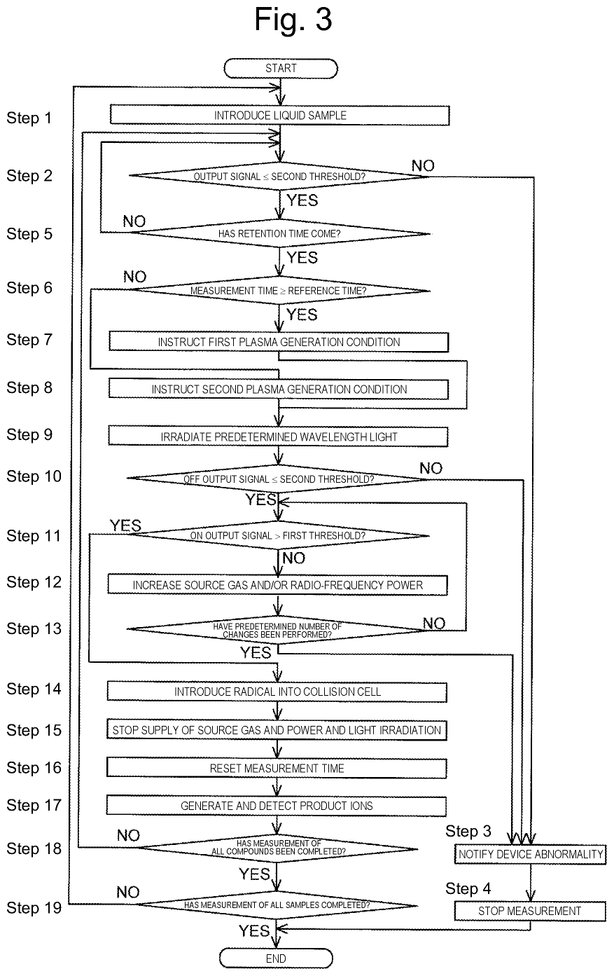

Next, a procedure for an analysis using the liquid chromatograph mass spectrometer 100 of the present embodiment will be described as an example of the mass spectrometry method according to the present invention. FIG. 3 is a flowchart illustrating an analysis procedure. In this example, the target component contained in each of a plurality of liquid samples is measured. In addition, it is assumed that several days have elapsed from the previous measurement of the liquid sample.

When a user gives an instruction to start the analysis by a predetermined input operation, the measurement condition setting part 73 displays the compound stored in the compound database 711 on the screen of the display part 9, and allows the user to designate one or more target compounds to be measured. When the user specifies the target compound, the measurement condition setting part 73 reads the measurement condition of each compound from the compound database 711, and creates a batch file for executing continuous measurement of a plurality of liquid samples.

After the batch file is created, when the user gives an instruction to start the measurement by a predetermined input operation, the measurement controller 74 operates the vacuum pump to exhaust the inside of the radical generation chamber 51 to a predetermined degree of vacuum.

Next, the measurement controller 74 introduces a liquid sample set at a predetermined position among a plurality of liquid samples set in the autosampler 24 by the user in advance as a first measurement sample into the injector 22 (Step 1). The liquid sample is introduced into the column 23 along a mobile phase flow fed from the mobile phase container 20 by the liquid feeding pump 21. After components contained in the liquid sample are temporally separated in the column 23, the separated components are sequentially introduced into the electrospray ionization probe 101.

The ions of the target compound generated by the electrospray ionization probe 101 are drawn into the first intermediate vacuum chamber 11 through the heated capillary 102 by a pressure difference between the ionization chamber 10 and the first intermediate vacuum chamber 11. In the first intermediate vacuum chamber 11, the ion lens 111 focuses the ions in the vicinity of the ion optical axis C.

The ions focused in the first intermediate vacuum chamber 11 subsequently enter the second intermediate vacuum chamber 12, are again focused in the vicinity of the ion optical axis C by the ion guide 121, and then enter the third intermediate vacuum chamber 13.

In the third intermediate vacuum chamber 13, the precursor ions are selected from the ions generated from the target compound by the quadrupole mass filter 131. The precursor ions having passed through the quadrupole mass filter 131 are introduced into the collision cell 132.

After starting the measurement, the photodetector 62 measures the intensity of light having a predetermined wavelength in the radical generation chamber 51 at predetermined time intervals. The output signals from the photodetector 62 are sequentially transmitted to the control/processing unit 7 and stored in the storage part 71. The photodetector 62 of the present embodiment is a photodiode, and a voltage signal is input to the control/processing unit 7 as an output signal. As described above, a device other than the photodiode may be used as the photodetector 62.

In the control/processing unit 7, the light intensity determination part 77 compares the value of the output signal from the photodetector 62 with the second threshold stored in the storage part 71. Then, in a case where the value of the output signal from the photodetector 62 is equal to or less than the second threshold (YES in Step 2), it is determined that no abnormality has occurred in the device. On the other hand, when the value of the output signal from photodetector 62 exceeds the second threshold (NO in Step 2), it is determined that an abnormality has occurred in the device. If the light intensity determination part 77 determines that an abnormality has occurred in the device, the abnormality information output part 78 displays that an abnormality has occurred in the device on the display part 9 (Step 3) and stops the measurement (Step 4). In this case, for example, the display part 9 may be notified of a message such as “External light is detected. Check the sealing status of the radical generation chamber”.

The output signal from the photodetector 62 reflects the intensity of light having a predetermined wavelength (light having a wavelength in a visible-light band included in plasma emission) in the radical generation chamber 51. If the radical generation chamber 51 is in a completely sealed state, plasma is not generated during this period (a period in which radio-frequency power is not supplied), and therefore, the output signal from the photodetector 62 cannot exceed the second threshold. The reason why the output signal from the photodetector 62 exceeds the second threshold during this period is considered that the radical generation chamber 51 is not completely sealed, and light outside the radical generation chamber 51 enters the radical generation chamber 51. When the measurement is continued in such a state, there is a risk that the deep ultraviolet light with which the target compound is irradiated during the retention time leaks to the outside of the radical generation chamber 51, and the human body is irradiated with the deep ultraviolet light. In the present embodiment, in a case where the output signal from the photodetector 62 exceeds the second threshold during this period, the abnormality information output part 78 notifies the abnormality of the device and ends the measurement. Therefore, even in a case where sealing of the radical generation chamber 51 is insufficient, safety can be secured.

At a predetermined time (for example, 1 minute) before the retention time of the target compound after the start of the measurement (YES in Step 5), the elapsed time determination part 75 acquires information on the measurement time by the timing unit 72. The predetermined time only needs to be determined as appropriate in consideration of the rising speed of the outflow amount when the target compound flows out from the column 23 and described in the method file.

If the elapsed time determination part 75 determines that the time equal to or longer than the reference time has elapsed since the last plasma generation (YES in Step 6), the plasma generation controller 76 transmits a control signal for setting the first plasma generation condition to the source gas supply 52 and the radio-frequency power supply part 53 (Step 7). On the other hand, if the elapsed time determination part 75 determines that the reference time has not elapsed since the last plasma generation (NO in Step 6), the plasma generation controller 76 transmits a control signal for setting the second plasma generation condition to the source gas supply 52 and the radio-frequency power supply part 53 (Step 8). A start control signal instructing a start of supply of a predetermined amount of source gas on the basis of the first plasma generation condition or the second plasma generation condition is transmitted to the source gas supply 52, and the source gas is introduced into the radical generation chamber 51. In addition, a control signal having a PWM waveform of a predetermined magnitude on the basis of the first plasma generation condition or the second plasma generation condition is transmitted to the radio-frequency power supply part 53, and radio-frequency power to be turned on/off based on the PWM waveform is supplied to the helical antenna 542 through the radio-frequency power input part 546.

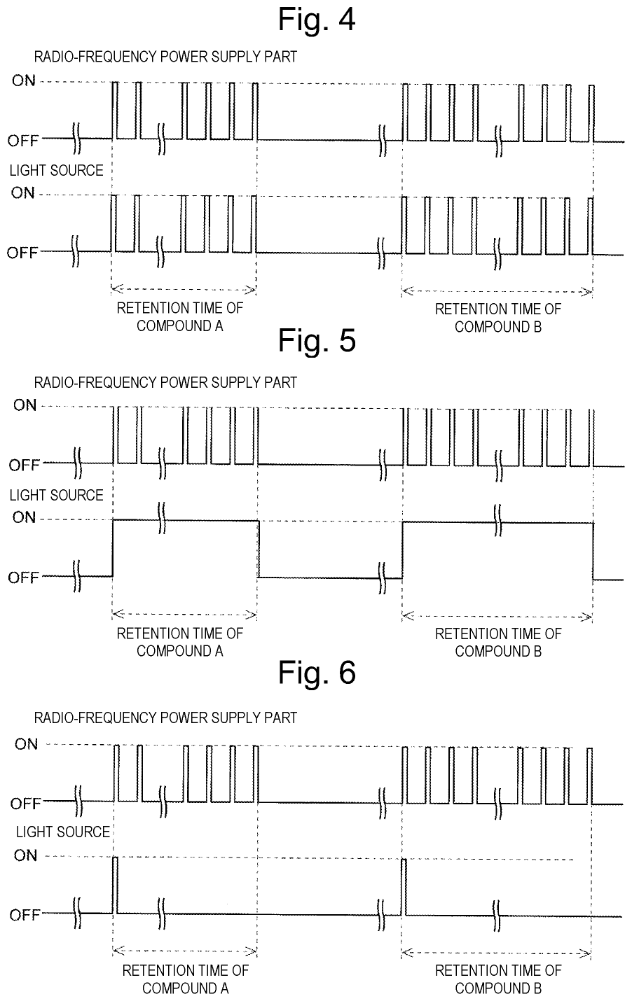

In addition, the plasma generation controller 76 also transmits a control signal to the light source 61 in a state where radio-frequency power is supplied to the source gas in the radical generation chamber 51, and irradiates the inside of the radical generation chamber 51 with light having a predetermined wavelength (Step 9). In the present embodiment, the radical generation chamber 51 can be irradiated with light as appropriate using three methods illustrated in FIGS. 4 to 6. In the method illustrated in FIG. 4, the same PWM control signal is transmitted to the radio-frequency power supply part 53 and the light source 61, and the radical generation chamber 51 is intermittently irradiated with deep ultraviolet light at the same timing as the supply of the radio-frequency power. In the method shown in FIG. 5, at a predetermined time (for example, 1 minute) before the retention time of the target compound, an ON control signal is also transmitted to the light source 61 at the same time as the control signal transmitted to the radio-frequency power supply part 53 first, and the light source 61 is kept ignited. Finally, the light source 61 is turned off at the same time as the OFF control signal transmitted to the radio-frequency power supply part 53. In the method shown in FIG. 6, at a predetermined time before the retention time of the target compound, at the same time as the ON control signal and the OFF control signal that are first transmitted to the radio-frequency power supply part 53, the ON control signal and the OFF control signal are transmitted to the light source 61 only once, and the light source 61 is ignited only once. Depending on the kind of the source gas, plasma may be easily generated or hardly generated. Therefore, these methods only need to be used according to cases such that, for example, the plasma is usually generated by the method shown in FIG. 4, the plasma is generated by the method shown in FIG. 5 in a case where the plasma is difficult to be generated, and the plasma is generated by the method shown in FIG. 6 in a case where the plasma is easily to be generated. Which method is adopted at the time of actual measurement can be determined in advance by performing a preliminary experiment or simulation.

The wavelength of the light with which the radical generation chamber 51 is irradiated is determined according to the material constituting the radical generation chamber 51. For example, in a case where the tubular body 541 made of quartz is used, light having a wavelength of 275 nm or less is emitted. As a result, electrons are emitted from the wall surface of the tubular body 541 constituting the radical generation chamber 51. Plasma emission is induced by the electrons.

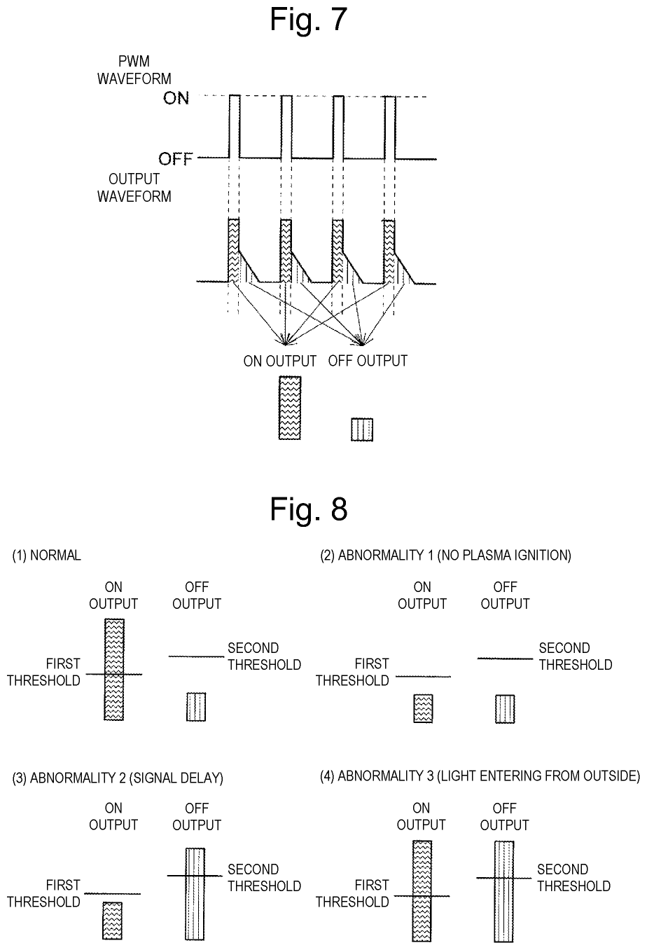

The light intensity determination part 77 receives a control signal (PWM waveform signal) transmitted from the plasma generation controller 76 to the radio-frequency power supply part 53 and an output signal (output voltage waveform signal) from the photodetector 62. Then, the light intensity determination part 77 determines whether the output signal from the photodetector 62 during a period in which the PWM waveform is OFF (period in which the radio-frequency power is not supplied to the radical generation chamber 51) is equal to or less than the second threshold (Step 10) and whether the output signal from the photodetector 62 during a period in which the PWM waveform is ON (period in which the radio-frequency power is supplied to the radical generation chamber 51) exceeds the first threshold (Step 11). The light intensity determination part 77 performs processing of separating the output signal (ON output signal in FIG. 3) of the photodetector 62 corresponding to the period in which the PWM waveform is ON and the output signal (OFF output signal in FIG. 3) of the photodetector corresponding to the period in which the PWM waveform is OFF, then summing each of them, and compares the output signal with the first threshold and the second threshold. As illustrated in FIG. 7, since the PWM waveform is a waveform that can be generated by digital control, ON/OFF is instantaneously switched, but the output signal from the photodetector 62 is an analog voltage signal, and thus, is a signal having a tail. Even if the inside of the radical generation chamber 51 is completely sealed, since the output signal from the photodetector 62 in the period in which the PWM waveform is OFF does not become zero, a time average is obtained for each of the output signals from the photodetector 62 in the period in which the PWM waveform is ON/OFF, and the time average is compared with the first threshold or the second threshold.

The fact that the output of the photodetector 62 exceeds the first threshold in the period in which the PWM waveform is ON is that plasma is generated in the radical generation chamber 51. In addition, the fact that the output of the photodetector 62 during the period in which the PWM waveform is OFF is equal to or less than the second threshold is that the inside of the radical generation chamber 51 is completely sealed and light from the outside does not enter.

As a result of the above determination, when the OFF output signal of the photodetector 62 is equal to or less than the second threshold (YES in Step 10) and the ON output signal exceeds the first threshold (YES in Step 10. Corresponding to normal in FIG. 8), the measurement is continued as it is, and the generated radicals are introduced into the collision cell 132 (Step 14).

When the OFF output signal of the photodetector 62 is equal to or less than the second threshold (YES in Step 10), but the output of the photodetector 62 during the period in which the PWM waveform is ON does not exceed the first threshold even after a predetermined time (for example, 5 seconds) has elapsed since the start of the determination (NO in Step 11. Corresponding to Abnormality 1 in FIG. 8), it is determined that the plasma is not turned on. In this case, the plasma generation controller 76 increases the supply amount of the radio-frequency power and/or the source gas by a predetermined magnitude (or ratio) (Step 12). If the number of changes has not reached the predetermined number of times (NO in Step 13), the process returns to Step 11 again. When the light intensity determination part 77 does not determine that the output of the photodetector 62 during the period in which the PWM waveform is ON exceeds the first threshold even if the supply amount of the radio-frequency power and/or the source gas is changed the predetermined number of times (YES in Step 13), it is determined that a failure has occurred in the source gas supply 52 or the radio-frequency power supply part 53. In this case, the abnormality information output part 78 displays that an abnormality has occurred in the device on the display part 9 (Step 3) and stops the measurement (Step 4). In this case, for example, the display part 9 may display a message such as “The plasma is not ignited even at the maximum output. Check the source gas supply part and the radio-frequency power supply part”.

When the OFF output signal of the photodetector 62 exceeds the second threshold (NO in Step 10), it is determined that an abnormality has occurred in the device. Then, the abnormality information output part 78 displays that an abnormality has occurred in the device on the display part 9 (Step 3) and stops the measurement (Step 4). Among these, in a case where the ON output signal of the photodetector 62 does not exceed the first threshold (corresponding to Abnormality 2 in FIG. 8.), it is conceivable that a signal delay occurs in the transmission path of the control signal and the reception path of the output signal from the photodetector 62 although the plasma is ignited at the timing when the radio-frequency power is supplied. In this case, the abnormality information output part 78 notifies the display part 9 of a message such as “A signal delay has occurred. Check the signal path”.

On the other hand, when the ON output signal of the photodetector 62 also exceeds the first threshold (corresponding to Abnormality 3 in FIG. 8.), it is conceivable that light enters from the outside of the radical generation chamber 51. In this case, the abnormality information output part 78 notifies the display part 9 of a message such as “External light has been detected. Check the sealing status of the radical generation chamber”.

When a predetermined time (for example, 1 minute) has elapsed from the retention time of the target compound, the plasma generation controller 76 stops the supply of the source gas and the radio-frequency power and the irradiation of light (Step 15). As a result, the plasma disappears, and the generation and supply of radicals are stopped. The predetermined time only needs to be determined as appropriate in consideration of the length of the retention time of the target compound (time during which the target compound flows out from the column 23) and described in the method file.

At the same time that the supply of the source gas, the input of the radio-frequency power, and the light irradiation are stopped, a predetermined signal is also transmitted to the timing unit 72, and the elapsed time measured in the timing unit 72 is reset (Step 16).

In the collision cell 132, precursor ions are dissociated by a radical attachment reaction to generate product ions. The product ions generated in the collision cell 132 are focused in the vicinity of the ion optical axis C by the ion guide 134, and then enter the analysis chamber 14.

The ion transport electrode 141 transports the product ions having entered the analysis chamber 14 to the orthogonal acceleration electrode 142. A voltage is applied to the orthogonal acceleration electrode 142 at a predetermined cycle to deflect the flight direction of the ions in a direction substantially orthogonal to the previous direction. The ions with the deflected flight direction are accelerated by the acceleration electrode 143, and ejected to the flight space. The ions ejected to the flight space fly along a predetermined flight path defined by the reflectron electrode 144 and the flight tube 146 for a time corresponding to the mass-to-charge ratio of each ion and are separated from each other, and are detected by the ion detector 145 (Step 17). The ion detector 145 outputs a signal having a magnitude corresponding to the incident amount of the ion every time the ion is incident. The output signals from the ion detector 145 are sequentially stored in the storage part 71. The storage part 71 stores measurement data with the time of flight of the ion and the detection intensity of the ion as axes.

When the measurement of the first liquid sample is completed, the measurement controller 74 confirms whether the measurement of all the target compounds is completed (whether the retention times of all the target compounds have elapsed) (Step 18). Since only the first target compound has been measured here, it is determined that the measurement of all target compounds has not been completed (NO in Step 18), and the process returns to Step 2 and then waits until the retention time of next target compound.

When the measurement of all the target compounds has been completed (YES in Step 18), it is confirmed whether the measurement of all the liquid samples has been completed. When there is an unmeasured liquid sample (NO in Step 19), the process returns to Step 1, and next liquid sample is introduced from the autosampler 24 to the injector 22. The procedures in the measurement of the second and subsequent target compounds and the measurement of the second and subsequent liquid samples are the same as described above, and thus the description thereof will be omitted.

In a conventional mass spectrometer, plasma is generated only by supplying source gas and supplying radio-frequency power, and plasma is not necessarily generated at a constant timing in some cases. Therefore, it is necessary to generate radicals in the radical supply part 5 before starting the measurement. Therefore, there is a problem that the consumption of the source gas and the radio-frequency power increases.

In contrast, in the mass spectrometer of the present embodiment, the tubular body 541 is irradiated with light of a predetermined wavelength from the light source 61, and electrons are emitted into the radical generation chamber 51. When the source gas is supplied and radio-frequency power is input, plasma emission is induced by the electrons, and radicals are immediately generated from the source gas irradiated with the plasma emission. Therefore, plasma may be generated immediately before the retention time of the target compound, and the use amount of the source gas and the radio-frequency power can be suppressed. In addition, it is possible to generate plasma more reliably at a desired timing and generate radicals as compared with a conventional configuration in which light irradiation is not performed.

In the mass spectrometer of the present embodiment, when the elapsed time from the last generation of the plasma is less than the reference time, the plasma is generated while suppressing the supply amount of the source gas and/or the input amount of the radio-frequency power. Therefore, also in this respect, the use amount of the source gas and the radio-frequency power can be suppressed.

In addition, in the mass spectrometer of the present embodiment, since the radio-frequency power to be ON/OFF is supplied by the PWM waveform, the plasma can be ignited under optimized conditions by appropriately determining the frequency and the duty ratio of the PWM waveform. In addition, as compared with a case where the plasma is continuously generated by constantly supplying the radio-frequency power, the temperature rise of each part constituting the radical generation chamber 51 is suppressed, so that it is possible to suppress the damage of the members constituting the radical generation chamber 51.

Furthermore, in the mass spectrometer of the present embodiment, it is determined whether or not the plasma is ignited by comparing the output signal from the photodetector 62 at the time of supplying the radio-frequency power (period in which the PWM waveform is ON) with the first threshold, and when the plasma is not ignited, the source gas and/or the radio-frequency power are increased with a predetermined magnitude or ratio. Therefore, it is not necessary to supply an excessive amount of the source gas and the radio-frequency power from the beginning, and the usage amount of the source gas and the radio-frequency power can also be suppressed in this respect. Since it is determined whether or not the device is normally operating by comparing the output signal from the photodetector 62 when the radio-frequency power is not supplied (during a period in which the PWM waveform is OFF) with the second threshold, and the abnormality is notified, the user can immediately notice the abnormality of the device in a case where the seal in the radical generation chamber 51 is not insufficient and light enters from the outside, or in a case where the supply of the radio-frequency power is undesirably continued due to the damage of the control circuit and the plasma is continuously generated.

The above-described embodiment is merely an example, and can be appropriately modified in accordance with the spirit of the invention. Although the liquid chromatograph mass spectrometer is used in the above embodiment, a gas chromatograph mass spectrometer may be used. Alternatively, only a mass spectrometer may be used without using a chromatograph. In the above embodiment, the quadrupole-orthogonal acceleration time-of-flight mass spectrometer is used, but a triple quadrupole mass spectrometer, an ion trap mass spectrometer, or the like can be used.

In the above embodiment, a configuration in which irradiation of the deep ultraviolet light is performed is employed in order to generate the plasma, but the light irradiation is not essential to the present invention, and the plasma may be generated without performing the light irradiation. In the above embodiment, the radical is generated by turning on the plasma only during the retention time of the target compound. However, for example, in a case where it is difficult to immediately ignite the plasma without performing light irradiation, the radical may be generated by continuously turning on the plasma during the measurement of the sample, and the valve 582 may be opened in accordance with the retention time of the target compound.

In the above embodiment, both the presence or absence of the ignition of the plasma and the presence or absence of the occurrence of the abnormality of the device are determined using the two types of thresholds of the first threshold (plasma ignition threshold) and the second threshold (abnormality determination threshold), but only the second threshold may be used. Even with the configuration using only the second threshold, the user can quickly find that an abnormality has occurred in the device as in the above embodiment.

In the above embodiment, the first radical generation condition and the second radical generation condition are prepared in advance, and when the output of the photodetector 62 during the period in which the PWM waveform is ON does not exceed the first threshold, the supply amount of the radio-frequency power and/or the supply amount of the source gas set in the first radical generation condition or the second radical generation condition is increased by a predetermined magnitude (or ratio). However, three or more radical generation conditions may be prepared, and when the output of the photodetector 62 during the period in which the PWM waveform is ON does not exceed the first threshold, the supply amount of the radio-frequency power and/or the supply amount of the source gas may be changed to a larger condition.

### Modes

It is understood by those skilled in the art that the plurality of exemplary embodiments described above are specific examples of the following modes.

### (Clause 1)

A mass spectrometry method according to one mode includes:
a step of introducing precursor ions into a reaction chamber;
a step of generating radicals from source gas by generating plasma inside a radical generation chamber by supplying the source gas and radio-frequency power to the radical generation chamber for a predetermined period by transmitting a predetermined control signal to a source gas supply part and a radio-frequency power supply part;
a step of generating product ions by introducing the radicals into the reaction chamber;
a step of measuring an intensity of light having a wavelength band including a wavelength of light emitted from the plasma inside the radical generation chamber; and
a step of determining and notifying an abnormality of the mass spectrometer on the basis of a fact that the intensity of the light exceeds a predetermined abnormality determination threshold value during a period other than the predetermined period.

### (Clause 7)

A mass spectrometer according to another mode includes:
a threshold storage part in which an abnormality determination threshold value is stored;
a reaction chamber into which precursor ions are introduced;
a radical generation chamber;
a source gas supply part configured to supply source gas to the inside of the radical generation chamber;
a radio-frequency power supply part configured to supply radio-frequency power for generating plasma inside the radical generation chamber;
a plasma generation controller configured to supply the source gas and the radio-frequency power to the radical generation chamber for a predetermined period by transmitting a predetermined control signal to the source gas supply part and the radio-frequency power supply part to generate plasma inside the radical generation chamber;
a photodetector configured to measure intensity of light having a wavelength band including a wavelength of light emitted from the plasma inside the radical generation chamber;
a light intensity determination part configured to determine whether or not the intensity of light measured by the photodetector during a period other than the predetermined period exceeds the abnormality determination threshold value; and
an abnormality notifier configured to notify an abnormality of the mass spectrometer when the light intensity determination part determines that the intensity of the light exceeds the abnormality determination threshold value.

In the mass spectrometry method according to Clause 1 and the mass spectrometer according to Clause 7, a predetermined control signal (start control signal) is transmitted to the source gas supply part and the radio-frequency power supply part, the source gas and the radio-frequency power are supplied to the radical generation chamber for a predetermined period to generate plasma inside the radical generation chamber, and radicals are generated from the source gas. The predetermined period is typically a part or all of the period during which precursor ions derived from the sample component to be analyzed are introduced into the reaction chamber. In the mass spectrometry method according to Clause 1 and the mass spectrometer according to Clause 7, the intensity of light having a wavelength band including the wavelength of light emitted from the plasma generated in the radical generation chamber is measured, the abnormality of the mass spectrometer is determined on the basis of the fact that the intensity of light exceeds a predetermined abnormality determination threshold value during a period other than the predetermined period, that is, during a period in which the supply of the source gas and the radio-frequency power is not instructed, and the abnormality is notified. Therefore, on the basis of this notification, the user can quickly confirm that the plasma is generated at an undesired timing due to the abnormality of mass spectrometer.

### (Clause 2)

The mass spectrometry method according to Clause 1, further includes
a step of irradiating the radical generation chamber with light having a predetermined wavelength in a state where the source gas and the radio-frequency power are supplied to the radical generation chamber.

### (Clause 8)

The mass spectrometer according to Clause 7, further includes
a light irradiation part configured to irradiate the radical generation chamber with light having a predetermined wavelength, wherein
the plasma generation controller is further configured to control the light irradiation part so as to irradiate the radical generation chamber with light having a predetermined wavelength in a state where the source gas and the radio-frequency power are supplied to the radical generation chamber.

In the mass spectrometry method according to Clause 2 and the mass spectrometer according to Clause 8, the radical generation chamber is irradiated with light of a predetermined wavelength, and electrons are supplied from the wall surface of the radical generation chamber, so that plasma can be immediately ignited.

### (Clause 3)

In the mass spectrometry method according to Clause 2,
in the step of measuring the intensity of light having a wavelength band including the wavelength of light emitted from the plasma, light having a wavelength different from the predetermined wavelength among the light emitted from the plasma is detected.

### (Clause 9)

In the mass spectrometer according to Clause 7 or Clause 8,
the light irradiation part is an LED light source configured to emit ultraviolet light, and
the photodetector is a photodiode having sensitivity in a visible light region.

In the mass spectrometry method according to Clause 3, it is possible to reliably detect an ignition of plasma without being affected by light applied to the radical generation chamber. As such a light irradiation part and a photodetector, for example, a UV-LED light source and a photodiode as described in Clause 7 can be used.

### (Clause 4)

In the mass spectrometry method according to any one of Clauses 1 to 3,
when the intensity of the light in the predetermined period does not exceed a predetermined plasma ignition threshold value, the supply amount of the source gas and/or the radio-frequency power is increased.

### (Clause 10)

In the mass spectrometer according to any one of clauses 7 to 9,
a plasma ignition threshold value is further stored in the threshold storage part,
the light intensity determination part further determines whether or not the intensity of the light in the predetermined period exceeds the plasma ignition threshold value, and
when the light intensity determination part determines that the intensity of the light does not exceed the plasma ignition threshold value, the plasma generation controller increases the supply amount of the source gas and/or the radio-frequency power.

In the mass spectrometry method according to Clause 4 and the mass spectrometer according to Clause 10, even when ignition of the plasma is not detected, the plasma can be ignited by increasing the supply amount of the source gas and/or the radio-frequency power.

### (Clause 5)

In the mass spectrometry method according to any one of Clauses 1 to 4,
during a period in which precursor ions are introduced into the reaction chamber, the control signal is repeatedly transmitted to the radio-frequency power supply part at a predetermined frequency and duty ratio.

In the mass spectrometry method according to Clause 5, by intermittently supplying radio-frequency power, it is possible to suppress temperature rise in the radical generation chamber and to suppress damage to each part constituting the radical generation chamber.

### (Clause 6)

In the mass spectrometry method according to Clause 5,
the frequency is less than 333 kHz.

In the mass spectrometry method according to Clause 6, a general photodiode or the like having a response characteristic of about 1.5 us is used as a photodetector, so that a device can be configured at low cost.

### REFERENCE SIGNS LIST

1 . . . Mass Spectrometer
10 . . . Ionization Chamber
101 . . . ESI Probe
11 . . . First Intermediate Vacuum Chamber
111 . . . Ion Lens
12 . . . Second Intermediate Vacuum Chamber
121 . . . Ion Guide
13 . . . Third Intermediate Vacuum Chamber
131 . . . Quadrupole Mass Filter
132 . . . Collision Cell
134 . . . Ion Guide
14 . . . Analysis Chamber
141 . . . Ion Transport Electrode
142 . . . Orthogonal Acceleration Electrode
143 . . . Acceleration Electrode
144 . . . Reflectron Electrode
145 . . . Ion Detector
146 . . . Flight Tube
2 . . . Liquid Chromatograph
20 . . . Mobile Phase Container
21 . . . Liquid Feeding Pump
22 . . . Injector
23 . . . Column
24 . . . Autosampler
4 . . . Collision Gas Supply Part
5 . . . Radical Supply Part
51 . . . Radical Generation Chamber
52 . . . Source Gas supply
53 . . . Radio-Frequency Power Supply Part
54 . . . Radical Source
541 . . . Tubular Body
542 . . . Helical Antenna
544, 548 . . . Magnet
546 . . . Radio-Frequency Power Input Part
547 . . . Flange
56 . . . Valve
58 . . . Transport Tube
581 . . . Head Part
582 . . . Valve
61 . . . Light Source
62 . . . Photodetector
7 . . . Control/Processing Unit
71 . . . Storage Part
711 . . . Compound Database
712 . . . Radical Information Database
72 . . . Timing Unit
73 . . . Measurement Condition Setting Part
74 . . . Measurement Controller
75 . . . Elapsed Time Determination Part
76 . . . Plasma Generation Controller
77 . . . Light Intensity Determination Part
78 . . . Abnormality Information Output Part
8 . . . Input Part
9 . . . Display Part
C . . . Ion Optical Axis

1. A method of operating a mass spectrometer comprising:
a step of introducing precursor ions into a reaction chamber;
a step of generating radicals from source gas by generating plasma inside a radical generation chamber by supplying the source gas and radio-frequency power to the radical generation chamber for a predetermined period by transmitting a predetermined control signal to a source gas supply part and a radio-frequency power supply part;
a step of generating product ions by introducing the radicals into the reaction chamber;
a step of measuring an intensity of light having a wavelength band including a wavelength of light emitted from the plasma inside the radical generation chamber; and
a step of determining and notifying an abnormality of the mass spectrometer on a basis of a fact that the intensity of the light exceeds a predetermined abnormality determination threshold value during a period other than the predetermined period.

2. The method of operating a mass spectrometer according to claim 1, further comprising:
a step of irradiating the radical generation chamber with light having a predetermined wavelength in a state where the source gas and the radio-frequency power are supplied to the radical generation chamber.

3. The method of operating a mass spectrometer according to claim 2, wherein in the step of measuring the intensity of light having a wavelength band including the wavelength of light emitted from the plasma, light having a wavelength different from the predetermined wavelength among the light emitted from the plasma is detected.

4. The method of operating a mass spectrometer according to claim 1, wherein when the intensity of the light in the predetermined period does not exceed a predetermined plasma ignition threshold value, the supply amount of the source gas and/or the radio-frequency power is increased.

5. The method of operating a mass spectrometer according to claim 1, wherein during a period in which precursor ions are introduced into the reaction chamber, the control signal is repeatedly transmitted to the radio-frequency power supply part at a predetermined frequency and duty ratio.

6. The method of operating a mass spectrometer according to claim 5, wherein the frequency is less than 333 kHz.

7. A mass spectrometer according comprising:
a threshold storage part that in which an abnormality determination threshold value is stored;
a reaction chamber into which precursor ions are introduced;
a radical generation chamber;
a source gas supply part configured to supply source gas to the inside of the radical generation chamber;
a radio-frequency power supply part configured to supply radio-frequency power for generating plasma inside the radical generation chamber;
a plasma generation controller configured to supply the source gas and the radio-frequency power to the radical generation chamber for a predetermined period by transmitting a predetermined control signal to the source gas supply part and the radio-frequency power supply part to generate plasma inside the radical generation chamber;
a photodetector configured to measure intensity of light having a wavelength band including a wavelength of light emitted from the plasma inside the radical generation chamber;
a light intensity determination part configured to determine whether or not the intensity of light measured by the photodetector during a period other than the predetermined period exceeds the abnormality determination threshold value; and
an abnormality notifier configured to notify an abnormality of the mass spectrometer when the light intensity determination part determines that the intensity of the light exceeds the abnormality determination threshold value.

8. The mass spectrometer according to claim 7, further comprising
a light irradiation part configured to irradiate the radical generation chamber with light having a predetermined wavelength, wherein
the plasma generation controller is further configured to control the light irradiation part so as to irradiate the radical generation chamber with light having a predetermined wavelength in a state where the source gas and the radio-frequency power are supplied to the radical generation chamber.

9. The mass spectrometer according to claim 8, wherein
the light irradiation part is an LED light source configured to emit ultraviolet light, and
the photodetector is a photodiode having sensitivity in a visible light region.

10. The mass spectrometer according to claim 7, wherein
a plasma ignition threshold value is further stored in the threshold storage part,
the light intensity determination part further determines whether or not the intensity of the light in the predetermined period exceeds the plasma ignition threshold value, and
when the light intensity determination part determines that the intensity of the light does not exceed the plasma ignition threshold value, the plasma generation controller increases the supply amount of the source gas and/or the radio-frequency power.
